(19) United States
(12) Patent Application Publication
(10) Pub. No.: US 2025/0154355 A1
(43) Pub. Date: May 15, 2025

(54) MINERAL-FILLED POLYAMIDE MOULDING COMPOUNDS

(71) Applicant: EMS-CHEMIE AG, Domat/Ems (CH)

(72) Inventor: Philipp HARDER, Chur (CH)

(73) Assignee: EMS-CHEMIE AG, Domat/Ems (CH)

(21) Appl. No.: 18/938,106

(22) Filed: Nov. 5, 2024

(30) Foreign Application Priority Data
Nov. 13, 2023 (CH) CH001256/2023

(51) Int. Cl. C08L 77/06; C08K 3/04; C08K 3/34; C08K 7/14; C08K 9/06

(52) U.S. Cl. CPC C08L 77/06; C08K 3/04; C08K 3/346; C08K 7/14; C08K 9/06; C08L 2205/025

(57) ABSTRACT

Disclosed is a mineral-filled thermoplastic polyamide moulding compound consisting of at least one polyamide; a mineral filler, glass or carbon fibers, a black colorant, and an additive. The polyamide moulding compound has a colour brightness L* of a maximum of 30 if the gloss is also measured and of a maximum of 12 if the gloss is not also measured. Also disclosed is a method for improving the deep black colour impression of a black-coloured, mineral-filled polyamide moulding compound.

### CROSS-REFERENCE TO RELATED APPLICATIONS

This patent application claims the benefit of Swiss Patent Application No. CH001256/2023, filed on Nov. 13, 2023.

### TECHNICAL FIELD

The present invention relates to thermoplastic, mineral-filled polyamide moulding compounds and moulded articles produced therefrom, which have a particularly deep black colour impression. The invention also relates to the use of specific mineral fillers in black-coloured, mineral-filled polyamide moulding compounds, specifically a mineral filler consisting of a mixture of crystalline silicic acid, amorphous silicic acid and calcined kaolin, to improve the deep black colour impression.

### PRIOR ART

Thermoplastic polyamide materials have established themselves for the production of structural components in many areas, particularly in the automotive sector, but also in the electronics sector, for example for housings of portable devices, due to their good mechanical properties, resistance to chemicals, good processability, low specific weight, etc.

Black-coloured moulding compounds are required in many applications. While a sufficiently deep black colour impression may be achieved with polyamide moulding compounds filled with glass fibres, mineral-filled polyamide moulding compounds tend to have an anthracite grey appearance. This is where the present invention comes in.

### DISCLOSURE OF THE INVENTION

Accordingly, it is the object of the invention to provide a mineral-filled, thermoplastic polyamide moulding compound which has suitable mechanical properties for the applications mentioned, but at the same time also produces a deep black colour impression.

In particular, it is the object of the invention to provide a mineral-filled polyamide moulding compound which has a colour brightness L*, determined according to DIN EN ISO 11664-4:2020 in the CIELAB colour space on a plate of the dimension 60×60×2 mm, of a maximum of 30 if the gloss is also measured and of a maximum of 12 if the gloss is not also measured.

This problem is solved by the subject matter of the present invention, in particular by a thermoplastic polyamide moulding compound modified in accordance with the invention as described herein, the moulded articles as described herein, and the use of a mineral filler consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% (B), respectively, wherein the component (B) has an aluminium oxide content of 5-20 wt.-% and a silicon oxide content of 80-95 wt.-%, in relation to 100% of (B), respectively, in a polyamide moulding compound for improving the deep black colour impression according to the present invention.

A core of the invention is thus ultimately that it was unexpectedly found that the use of a mineral filler consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% of (B), respectively, wherein the component (B) has an aluminium oxide content of 5-20 wt.-% and a silicon oxide content of 80-95 wt.-%, in relation to 100% of (B), respectively, as a substitute for other mineral fillers in a thermoplastic, black-coloured polyamide matrix, results in the deep black colour impression being exceptionally significantly improved. This is achieved without losing any of the favourable mechanical properties.

It is generally known from other fields that a filler consisting of a mixture of (crypto)crystalline silicic acid, amorphous silicic acid and calcined kaolin may be admixed to a polyamide material, but this is not in conjunction with the improvement of a deep black colour impression and also not in conjunction with the specific polyamide moulding compounds as described here.

In particular, reference should be made to the following documents in conjunction with the prior art:

WO2018069055 discloses fire-retardant, thermoplastic polyamide moulding compounds which, in addition to a melamine compound, contain a mineral filler constructed from a mixture of substantially (crypto)crystalline and amorphous silicic acid and calcined kaolin. The moulding compounds should have good mechanical properties and good flame retardancy. In particular, the addition of mineral fillers should enable flame retardancy that results in the shortest possible afterburning times during the glow wire test. It is also emphasized that the moulding compounds may be coloured particularly well in light colours.

The thermoplastic polyamide moulding compounds proposed here in the context of this application are preferably free of flame retardants, in particular free of melamine compounds.

WO2016/202359 relates to the field of adhesives and in particular to the field of moisture-curing or curing adhesives. The adhesives described offer high strength for the bonding of materials such as wood, concrete, plastics, stone etc. and have high moisture resistance at the same time. Claimed are adhesives comprising modified polyethers, fillers, adhesion promoters, and further one or more compounds selected from the group consisting of a free radical scavenger, a moisture scavenger, an antioxidant, a rheological modifier and a catalyst. One of the preferred fillers is Neuburg Silicate Earth.

More specifically, the present invention relates accordingly to a thermoplastic polyamide moulding compound consisting of:
(A) 20-89.9 wt.-% of at least one polyamide;
(B) 10-55 wt.-% of mineral filler, consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% (B), respectively, wherein the component (B) has an aluminium oxide content of 5-20 wt.-%, and a silicon oxide content of 80-95 wt.-%, in relation to 100% of (B);
(C) 0-15 wt.-% of glass and/or carbon fibres;
(D) 0.1-5.0 wt.-% of black colourant;
(E) 0-5.0 wt.-% of additives;
   wherein the sum of components (A) to (E) is 100% of the thermoplastic polyamide moulding compound.

The reference to the individual concentration ranges of components (A) to (E), to the sum of components (A) to (E) or to the moulding compound are to be regarded as equivalent within the context of the present invention.

For the purposes of the present invention, the term “polyamide” (abbreviation PA) is understood to be a generic term which includes homopolyamides and copolyamides. The chosen notations and abbreviations for polyamides and their monomers correspond to those specified in ISO standard 16396-1 (2015(D)). The abbreviations used therein are used in the following as synonyms for the IUPAC names of the monomers, in particular the following abbreviations for monomers are used: BAC for bis(aminomethyl)cyclohexane, wherein this includes 1,3-bis(aminomethyl)cyclohexane (1,3-BAC) and 1,4-bis(aminomethyl)cyclohexane (1,4-BAC), MACM for bis(4-amino-3-methyl-cyclohexyl)methane (also known as 3,3′-dimethyl-4,4′-diaminodicyclohexylmethane, CAS No. 6864-37-5), PACM for bis(4-amino-cyclohexyl)methane (also known as 4,4′-diaminodicyclohexylmethane, CAS no. 1761-71-3), TMDC for bis(4-amino-3,5-dimethyl-cyclohexyl)methane (also known as 3,3′,5,5′-tetramethyl-4,4′-diaminodicyclohexylmethane, CAS No. 65962-45-0), T for terephthalic acid (CAS No. 100-21-0), and I for isophthalic acid (CAS No. 121-95-5).

Compared to semi-crystalline polyamides, amorphous polyamides have no or only a very low, barely detectable heat of fusion. In dynamic differential calorimetry (DSC) according to ISO 11357 (2013) at a heating rate of 20 K/min, the amorphous polyamides show the following behaviour: preferably a heat of fusion of a maximum of 5 J/g, particularly preferably of a maximum of 3 J/g, very particularly preferably of 0 to 1 J/g. Amorphous polyamides have no melting point due to their amorphous nature.

Within the context of the invention, semi-crystalline polyamides are polyamides which, in dynamic differential calorimetry (DSC) according to ISO 11357 (2013) at a heating rate of 20 K/min, preferably have a heat of fusion of more than 5 J/g, particularly preferably of at least 25 J/g, very particularly preferably of at least 30 J/g.

The colour impression of the moulding compounds coloured in accordance with the invention and moulded articles produced from them may be described using the CIE standard colour system. DIN EN ISO 11664-2020 (parts 1 to 4) specifies spectral value functions for use in colorimetry and describes the corresponding colour measurements. The measurement is carried out as the ratio of reflection or transmission of a sample relative to a reference standard (=white standard) and is therefore independent of the light source. The values L*, a* and b* may be determined from the spectral data using the tabulated standard colour values. The reflected or transmitted light is analysed using a “monochromator” system consisting of an optical diffraction grating (prism), which splits the light and images it onto a photo diode array. The interaction of the material surface with the light (reflection) may be directed or diffuse, depending on the nature of the surface. Scattered light causes a dark surface to appear brighter when viewed. This is taken into account using standard spherical geometries. Gloss may be included or excluded by using the following measurement modes:

Measurement mode A: Reflection, measurement geometry: D/8°, illuminant: D 65 10, gloss: included, calibration: UV-calibrated, measurement aperture: SAV;

Measurement mode B: Reflection, measurement geometry: D/8°, illuminant: D 65 10, gloss: excluded, calibration: UV-calibrated, measurement aperture: SAV.

The term gloss exclusion in conjunction with the luminance measurement or the luminance values is to be regarded as equivalent to the following formulations: gloss excluded, measurement without gloss, measurement without gloss content, without gloss.

The term gloss inclusion in conjunction with the luminance measurement or the luminance values is to be regarded as equivalent to the following formulations: gloss included, measurement with gloss, measurement with gloss content, with gloss.

The use of the mineral fillers (B) according to the invention enables the production of coloured, mineral-filled thermoplastic moulding compounds that have a deep black colour impression. In the CIELAB colour space according to DIN EN ISO 11664-2020, L* values of no more than 12, preferably no more than 8, particularly preferably no more than 6 are achieved when measured without gloss content. When measuring with gloss content, L* values of at most 30, preferably at most 28, particularly preferably at most 27 are achieved.

According to a first preferred embodiment, the moulding compound is characterised in that component (A) is present in the moulding compound in a proportion of 28 to 84.9 wt.-%, preferably in a range of 50 to 79.8 wt.-%.

In a preferred embodiment, component (A) may consist exclusively of the semi-crystalline polyamides (A1). The polyamides (A1) are aliphatic semi-crystalline polyamides based on aliphatic dicarboxylic acids and aliphatic diamines and/or partially aromatic semi-crystalline polyamides based on dicarboxylic acids and diamines, wherein the diacids or diamines contain aromatic structural units.

In a further preferred embodiment, component (A) may comprise a mixture of the semi-crystalline polyamides (A1) and the amorphous polyamides (A2). Component (A) preferably consists of the following components:
(A1) 20-100 wt.-%, preferably 40-85 wt.-% of at least one aliphatic semi-crystalline polyamide based on aliphatic dicarboxylic acids and aliphatic diamines and/or at least one partially aromatic semi-crystalline polyamide based on dicarboxylic acids and diamines.
(A2) 0-80 wt.-%, preferably 15-60 wt.-% of at least one amorphous polyamide, wherein the wt.-% of components (A1) and (A2) add up to 100 wt.-% of component (A).

The polyamides of components (A1) and (A2) are preferably of the AABB type, i.e., constructed from dicarboxylic acids and diamines, wherein lactams and amino acids may also be present as components in a subordinate proportion.

The following monomers, for example, may be used as diamines for component (A1): 1,4-butanediamine, 2-methyl-1,5-pentanediamine, 2-butyl-2-ethyl-1,5-pentanediamine, 1,6-hexanediamine, 2,2,4-trimethylhexamethylenediamine, 2,4,4-trimethylhexamethylenediamine, 1,7-heptanediamine, 1,8-octanediamine, 2-methyl-1,8-octanediamine, 1,9-nonanediamine, 1,10-decanediamine, 1,11-undecanediamine, 1,12-dodecanediamine, 1,13-tridecanediamine, 1,14-tetradecanediamine, 1,3-bis-(aminomethyl)cyclohexane, 1,4-bis-(aminomethyl)cyclohexane, m-xylylenediamine and p-xylylenediamine, wherein 1,6-hexanediamine, 1,10-decanediamine, 1,12-dodecanediamine and 1,3-bis-(aminomethyl)cyclohexane are preferred.

The following monomers, for example, are suitable as dicarboxylic acids for component (A1): adipic acid, cork acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, C36 dimer fatty acid, cis- and/or trans-cyclohexane-1,4-dicarboxylic acid and/or cis-and/or trans-cyclohexane-1,3-dicarboxylic acid, terephthalic acid, isophthalic acid, naphthalene dicarboxylic acid, in particular 1,5-naphthalene dicarboxylic acid and 2,6-naphthalene dicarboxylic acid, and mixtures thereof. Adipic acid, sebacic acid, tetradecanedioic acid, hexadecanedioic acid and dodecanedioic acid are preferred.

Furthermore, the polyamides (A1) and (A2) may also contain lactams or aminocarboxylic acids, in particular α,ω-amino acids or lactams with 6 to 12 carbon atoms, wherein the following selection is given by way of example: m-aminobenzoic acid, p-aminobenzoic acid caprolactam (CL), α,ω-aminocaproic acid, α,ω-aminoheptanoic acid, α,ω-aminooctanoic acid, α,ω-aminononanoic acid, α,ω-aminodecanoic acid, α,ω-aminoundecanoic acid (AUA), lauric lactam (LL) and α,ω-aminododecanoic acid (ADA). Particularly preferred are caprolactam, aminocaproic acid, α,ω-aminoundecanoic acid, lauric lactam and α,ω-aminododecanoic acid. However, the proportion of these lactams or amino acids is preferably less than 50 wt.-% in relation to the total mass of the polyamide (A1), in particular preferably less than 20 wt.-%, particularly preferably less than ten wt.-%.

The polyamides of component (A1) are preferably semi-crystalline aliphatic polyamides selected from the group consisting of: PA 6, 46, 56, 66, 66/BAC6, 66/6, 69, 610, 612, 614, 616, 618, 810, 1010, 1012, 1212, 11, 12, 6/12, 66/6/610, wherein 66, 66/BAC6 and 610 are preferred and 66/BAC6, wherein BAC is equal to 1,3-BAC, is particularly preferred,
and/or semi-crystalline partially aromatic polyamides selected from the group consisting of: PA 6T/6I, 6T/66, 6T/6I/66, 6T/610, 6T/612, 6T/614, 6T/616, 9T, 9MT (M=2-methyloctane-1,8-diamine), 10T, 11T, 10T/6T, 11T/6T, 12T, 10T/6T, 11/10T, 12/10T, 11/9T, 12/9T, 10T/1010, 10T/612, wherein the proportion of terephthalic acid relative to the total content of dicarboxylic acids is preferably more than 50 mol %, in particular preferably more than 55 mol %,
and/or semi-crystalline polyamides which have a melting point of at least 170° C., preferably in the range of 175-340° C. or, preferably if aliphatic, in the range of 175-265° C.

Very particularly preferred is polyamide 66/BAC6 as component (A1) with a molar ratio 66:BAC6 of 75:25 to 55:45, in particular of 70:30 to 60:40, wherein BAC is preferably 1,3-bis(aminomethyl)cyclohexane (1,3-BAC).

Furthermore, the polyamides of component (A), (A1) and (A2), preferably have a relative viscosity measured in m-cresol (0.5 g polymer in 100 ml m-cresol, 20° C.) according to ISO 307 (2007) in the range of 1.4 to 3.0, particularly preferably in the range of 1.45 to 2.70, in particular preferably in the range of 1.50 to 2.40.

The polyamides of component (A2) are preferably selected from the group consisting of the amorphous polyamides 12/MACMT, MACM10, MACM12, MACM14, MACM16, MACM18, MACMI/12, PACM10, PACM12, PACM14, PACM16, PACM18, PACMI/12, TMDC10, TMDC12, TMDC16, TMDC18, MACMT/MACMI/12, PACMT/PACMI/12, or mixtures thereof,
and/or selected from the group consisting of the amorphous polyamides MXDI, MXDI/6I, MXD6/MXDI, 6I, 6/6I, 6T/6I, 10T/10I, 3-6T (3-6=2,2,4- or 2,4,4-trimethylhexanediamine) or mixtures thereof, wherein the systems 6T/6I or 10T/10I have a proportion of less than 50 mol %6T or 10T units, and wherein a composition range 6T:6I or 10T/10I of 20:80 to 45:55, in particular 25:75 to 40:60, is preferred,
and/or amorphous polyamides which have a glass transition temperature (Tg) above 90° C., particularly preferably above 110° C., in particular preferably above 120° C.

The diamines for the amorphous polyamides of component (A2) are preferably selected here from the group consisting of 1,6-diaminehexane, 1,10-diaminodecane, 1,12-diaminododecane, bis-(4-amino-3-methyl-cyclohexyl)-methane (MACM), bis-(4-amino-cyclohexyl)-methane (PACM), bis-(4-amino-3-ethyl-cyclohexyl)-methane (EACM), bis-(4-amino-3,5-dimethyl-cyclohexyl)-methane (TMDC), 2,6-norbornanediamine (2,6-bis-(aminomethyl)-norbornane), 1,3-diaminocyclohexane, 1,4-diaminocyclohexane, isophorone diamine, 1,3-bis-(aminomethyl)cyclohexane, 1,4-bis-(aminomethyl)cyclohexane, 2,2-(4,4′-diaminodicyclohexyl)propane, meta-xylylenediamine, para-xylylenediamine and mixtures thereof. The diamines are particularly preferably selected from the group consisting of hexane-1,6-diamine, decane-1,10-diamine, bis-(4-amino-3-methyl-cyclohexyl)-methane (MACM) and bis(4-amino-cyclohexyl)methane (PACM) and mixtures thereof.

Dicarboxylic acids for the polyamides (A2) are preferably selected from the group consisting of terephthalic acid, isophthalic acid, naphthalene dicarboxylic acids (NDA), in particular 1,5-naphthalene dicarboxylic acid and 2,6-naphthalene dicarboxylic acid, 1,6-hexanedioic acid (adipic acid), 1,9-nonanedioic acid, 1,10-decanedioic acid, 1,11-undecanedioic acid, 1,12-dodecanedioic acid, 1,13-tridecanedioic acid, 1,14-tetradecanedioic acid, 1,16-hexadecanedioic acid, 1,18-octadecanedioic acid, and mixtures thereof. Particularly preferred are 1,6-hexanedioic acid, 1,10-decanedioic acid, 1,12-dodecanedioic acid, terephthalic acid, isophthalic acid and mixtures thereof. Furthermore, caprolactam and lauric lactam are preferred monomers for the production of the polyamides of component (A2).

In accordance with the invention, the moulding compound, besides the polyamide matrix, has a certain proportion of a mineral filler as component (B). Preferably, the proportion of component (B) in the moulding compound is in the range of 15-50 wt.-%, preferably in the range of 20-45 wt.-%.

Surprisingly particularly suitable as component (B) is a naturally occurring mineral filler, which consists of a mixture of corpuscular, (crypto)crystalline and amorphous silicic acid and calcined lamellar kaolin. The mineral mixture is a loose, crystalline material heap that is unable to be separated by physical methods. The silicic acid proportion has a round grain shape and consists of aggregated cryptocrystalline primary particles, which are approximately 200 nm in size and are coated with amorphous silicic acid like an opal. This structure results in a relatively high specific surface area and oil absorption value.

As component (B), the moulding compounds according to the invention contain 10 to 55, preferably 15 to 50 and particularly preferably 20 to 45 wt.-% of a mineral filler constructed from a mixture of substantially (crypto) crystalline (B1) and amorphous silicic acid (B2) and calcined kaolin (B3).

The mineral filler (B) contains a mixture of 45 to 70, preferably 53 to 65 wt.-% of (B1) with 5 to 15, preferably 7 to 12 wt.-% of (B2) and 20 to 40, preferably 25 to 35 wt.-% of (B3), in relation to 100 wt.-% of (B).

Component (B) has an aluminium oxide content of 5 to 20 wt.-%, preferably 7 to 17 and in particular 8 to 15 wt.-%, in relation to 100 wt.-% of (B). In addition, component (B) has a silica content of 80 to 95 wt.-%, preferably 83 to 93 and in particular 85 to 92 wt.-%, in relation to 100 wt.-% of (B). Both the silicon oxide and the aluminium oxide content may be determined using XRF (X-ray fluorescence analysis) in accordance with DIN 51001.

In a preferred embodiment, component (B) is a mineral filler consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% of (B), respectively, wherein component (B) has an aluminium oxide content of 5-20 wt.-% and a silicon oxide content of 80-95 wt.-%, in relation to 100% of (B).

Preferred components (B) have a specific BET surface area according to DIN ISO 9277 of 5 to 15, preferably 6 to 10 m²/g and/or an oil absorption value according to DIN ISO 787 part 5 of 50 to 60, preferably of 52 to 58 g/100 g.

For better compatibility with the polymer matrix, the mineral filler (B) may be surface-treated, wherein preferably silane compounds, particularly preferably aminosilane compounds are used.

Preferred silane compounds are trialkoxysilanes, dialkoxysilanes, epoxysilanes, vinylsilanes, (meth)acryloxysilanes, aminosilanes and mercaptosilanes.

Suitable representatives of these silane compounds are, for example γ-glycidoxypropylmethyl-dimethoxysilane, γ-glycidoxypropylmethyldiethoxysilane, vinylmethyldimethoxy-silane, vinylmethyldiethoxysilane, γ-(meth)acryloxypropylmethyldimethoxysilane, γ-(meth)acryloxypropylmethyldiethoxysilane, γ((meth)acryloxymethyl)methyldimethoxy-silane, γ-aminopropylmethyldiethoxysilane, N-β-(aminoethyl)-γ-aminopropylmethyl-dimethoxysilane, N-β-(aminoethyl)-γ-aminopropyl-methyldimethoxysilane, N-β-(aminoethyl)-γ-aminoisobutylmethyldimethoxysilane, γ-aminopropylmethyldi-methoxysilane, N-β-(aminoethyl)-γ-aminopropyl-methyldiethoxysilane, 3-mercaptopropylmethyldimethoxysilane, γ-aminopropylmethyldiethoxysilane, N-β-(aminoethyl)-γ-aminopropylmethyl-dimethoxysilane, N-β-(aminoethyl)-γ-amino-propylmethyldimethoxysilane, N-β-(aminoethyl)-γ-aminoisobutylmethyldimethoxy-silane, γ-aminopropylmethyl-dimethoxysilane, N-β-(aminoethyl)-γ-aminopropyl-methyldiethoxysilane, γ-aminopropyltriethoxysilane, γ-aminopropyl-trimethoxysilane, N-β-(aminoethyl)-γ-aminopropyl-trimethoxysilane, N-β-(aminoethyl)-γ-aminopropyl-triethoxysilane, diethylenetriaminopropyltrimethoxysilane, bis-(γ-trimethoxy-silylpropyl) amine, N-phenyl-γ-aminopropyltrimethoxysilane, γ-amino-3,3-dimethylbutyltrimethoxysilane, γ-aminobutyltriethoxysilane, and polyazamide silane.

Particularly preferred silane compounds are primary and secondary aminosilane compounds, such as aminopropyltrimethoxysilane, aminobutyltrimethoxysilane, aminopropyltriethoxysilane, aminobutyltriethoxysilane, bis(3-triethoxysilylpropyl)amine and N-[3-(trimethoxysilyl)-propyl]-ethylenediamine.

Secondary aminosilanes are preferred in particular, wherein bis(3-triethoxysilylpropyl)amine and N-[3-(trimethoxysilyl)-propyl]-ethylenediamine are particularly preferred.

The silane compounds are generally used in quantities of 0.01 to 2, preferably 0.025 to 1.0 and in particular 0.05 to 0.5 wt.-%, in relation to component (B), respectively, for surface coating.

Particularly preferably, the mineral filler (B) according to the invention is surface- coated with a primary and/or secondary aminosilane, in particular preferably with a secondary aminosilane, wherein the amount of the primary and/or secondary aminosilane is 0.01 to 2.0 wt.-%, preferably 0.025 to 1.0 wt.-%, in relation to component (B).

In a preferred embodiment, component (B) is a mineral filler consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% (B), respectively, wherein the component (B) has an aluminium oxide content of 5-20 wt.-%, and a silicon oxide content of 80-95 wt.-%, in relation to 100% (B), and wherein the mineral filler (B) is surface-coated with a primary and/or secondary aminosilane, in particular preferably with a secondary aminosilane, wherein the amount of the primary and/or secondary aminosilane is 0.01 to 2.0 wt.-%, preferably 0.025 to 1.0 wt.-%, in relation to component (B).

The polyamide moulding compound according to the invention may also contain, as component (C), reinforcing fibres, in particular glass fibres and/or carbon fibres. Component (C) is contained in the moulding compound in an amount of 0 to 15 wt.-%, in relation to the sum of components (A) to (E). Particularly preferably, the moulding compound is free of component (C), i.e., in this preferred embodiment, the moulding compound according to the invention does not contain any reinforcing fibres, i.e., no glass fibres and/or carbon fibres.

The reinforcing fibres may be in the form of chopped fibres (cut fibres) or continuous fibres (roving). The reinforcing fibre C is preferably a glass fibre.

Suitable glass fibres have a diameter of 6 to 20 μm, preferably 6 to 17 μm, particularly preferably 6 to 13 μm, very particularly preferably 7 to 12 μm. The glass fibres may consist of all types of glass, such as D, E, ECR, L, S, R glass, or any mixtures thereof. Glass fibres made of E-glass, ECR-glass or S-glass or mixtures of these fibres are preferred.

Suitable glass fibres have a cross-sectional area which may be either circular or non-circular, wherein in the latter case the dimensional ratio of the major cross-sectional axis to the minor cross-sectional axis is at least 2, preferably in the range of 2 to 5.

The reinforcing fibres, in particular the glass fibres, may be provided with a sizing suitable for thermoplastics, in particular for polyamide, containing an adhesion promoter based on an amino or epoxysilane compound.

In addition, the proposed moulding compound contains, besides the polyamide and the mineral filler according to the invention, at least one black colourant for colouring the moulding compound, more specifically as component (D). The component (D) is preferably present in a proportion in the range of 0.1-3.0 wt.-%, preferably in the range of 0.1-2.0 wt.-% in the moulding compound.

Component (D) is constituted by colourants or mixtures of colourants that are suitable for colouring the polyamide moulding compound dark or black. Colourants may be organic or inorganic, dyes or pigments. Dyes are colourants that do not normally scatter light, but absorb light at a certain visible wavelength. Dyes are often soluble in the polymer matrix in a certain concentration. Pigments are organic or inorganic dyes that are usually present as discrete particles that are insoluble in the polymer matrix.

According to the invention, colourants are used in quantities and in combinations sufficient to make the moulding compounds dark and opaque, and in particular to achieve the colour brightness values (L*, luminance) described below. The specific quantity of a colourant used depends, among other things, on its solubility and extinction coefficient in the thermoplastic matrix and on whether it is used in combination with one or more additional colourants.

Suitable colourants generally have high extinction coefficients in the visible wavelength range and high thermal stability. The colourants have a high thermal stability if no significant colour shift or thermal degradation is observed during the production and processing of the coloured moulding compounds by injection moulding or extrusion in the temperature range between 230 and 300° C. Furthermore, the colourants should not attack or degrade the polymer, which may lead to an unacceptable loss of mechanical properties or the formation of gaseous by-products during moulding.

In the context of the present invention, the black colourant may also be derived from a mixture of non-black, i.e., coloured pigments or dyes, if the mixture of these individual colourants (dyes or pigments) results in a black colour overall or allows the moulding compound to be coloured black.

The colourants (dyes and pigments) that may preferably be used as component (D) include carbon black, graphite, graphene, nigrosine, black pigments or dyes as well as combinations of complementary coloured pigments or dyes that allow a black colouring effect to be achieved when mixed, or mixtures of one or more of these colourants.

Particularly preferred for combinations of complementary coloured pigments or dyes are the colourants selected from the group of the following dye mixtures (indicated as Color Index Generic Names (CIGN)):
Solvent Green 3 and Solvent Red 179.
Solvent Red 52 and Solvent Blue 97.
Solvent Green 3, Solvent Blue 97 and Solvent Red 179.

A very particularly preferred colourant is a mixture (D) of the following components (indicated as Color Index Generic Names (CIGN)):
(D1) 20-40 wt.-% Solvent Green 3
(D2) 10-30 wt.-% Solvent Blue 97
(D3) 40-70 wt.-% Solvent Red 179
   wherein the sum of the components (D1) to (D3) gives 100 wt.-% of the mixture (D). Preferably, the content of this colourant mixture D is 0.15 to 0.25 wt.-% in relation to the sum of components (A) to (E).

Another preferred colourant is carbon black. Carbon black, also known as industrial carbon black, is a modification of carbon with a high surface-to-volume ratio and consists to an extent of 80 to 99.5 wt.-% of carbon. The specific surface area of industrial carbon black is approximately 10 to 1500 m²/g (BET). The carbon black may be produced as gas carbon black, furnace carbon black, flame carbon black, cracked carbon black or acetylene carbon black. The grain diameter is in the range of 8 to 500 nm, typically 8 to 110 nm. Carbon black is also known as Pigment Black 7 or Lamp Black 6. Coloured carbon blacks are nano-particulate carbon blacks that increasingly lose the brown basic tone of conventional carbon blacks due to their fineness.

The following black colour pigments may also be used as colourants: iron oxide black (Fe₃O₄), spinel black (Cu(Cr,Fe)₂O₄), manganese black (mixture of manganese dioxide, silica and iron oxide), cobalt black and antimony black.

Nigrosine may also be used for black colouring. Nigrosines are generally a group of blue, black or grey phenazine dyes (azine dyes) related to indulines in various forms (water-soluble, oil-soluble, alcohol-soluble). The nigrosine dye may be synthesised, for example, by oxidation and dehydrating condensation of aniline, aniline hydrochloride and nitrobenzene by heating in the presence of metallic iron or copper and metal salts such as ferric chloride (FeCl₃) at a reaction temperature of 160 to 180° C. Nigrosine is produced as a mixture of different compounds, depending on the reaction conditions, raw materials used, charge ratio and the like; for example, it is postulated that nigrosine may be a mixture of different triphenazinoxazines and phenazinazine compounds. Nigrosines may be used in the form of the free base or in the form of a salt (e.g., hydrochloride).

The nigrosine of the present invention may be the black azine series mixture which is described in the COLOR INDEX as C.I. Acid Black 2, C.I. SOLVENT BLACK 5, C.I. SOLVENT BLACK 5:1, C.I. SOLVENT BLACK 5:2 and C.I. SOLVENT BLACK 7 (C.I. Generic Names according to the third edition of the COLOUR INDEX).

Examples of commercially available nigrosine dyes are Spirit Black SB, Spirit Black SSBB, Spirit Black AB (all are categorised under C.I. SOLVENT BLACK 5); Nigrosin Base SA, Nigrosin Base SAP, Nigrosin Base SAP-L, Nigrosin Base EE, Nigrosin Base EE-L, Nigrosin Base EX, Nigrosin Base EX-BP (all classified under C.I. SOLVENT BLACK 7), all are products of Orient Chemical Industries, Ltd. C.I. SOLVENT BLACK 7 (CAS No. 8005 Feb. 5) is preferably used.

The colourants mentioned may be introduced into the moulding compound according to the invention as a masterbatch or concentrate, preferably based on polyamides (A), preferably polyamides (A1), wherein the content of colourant is preferably in the range of 20 to 50 wt.-%. The aliphatic polyamides PA6, PA66, PA66/BAC6, PA610, PA6/12, PA12 or mixtures thereof are preferably used as the basis for these masterbatches.

Preferably used as component (D) are black colourants selected from the group consisting of carbon black, graphite, graphene, nigrosine, black colour pigments, black dyes or combinations of complementary coloured pigments and/or dyes or mixtures of one or more of these colourants.

Preferably, the polyamide moulding compounds according to the invention are provided with colourants (component D) in such a way that the colour brightness L* (luminance) measured in the CIE-LAB light space is a maximum of 28, particularly preferably a maximum of 27, if the gloss is included, and the colour brightness L* is a maximum of 8, particularly preferably a maximum of 6, if the gloss is excluded.

Last but not least, the proposed moulding compound may also contain additives as component (E). Component (E), which is different from components A to D, is preferably present in a proportion in the range of 0 to 4.0 wt.-%, preferably 0.1 to 3.0 wt.-% in the moulding compound.

The additives of component (E) may be selected from the group consisting of: Stabilsers, anti-ageing agents, antioxidants, antiozonants, light stabilizers, UV stabilizers, UV absorbers, UV blockers, inorganic heat stabilisers, in particular based on copper halides and alkali halides, organic heat stabilizers, conductivity additives, processing aids, nucleating agents, crystallization accelerators, crystallization retarders, flow aids, lubricants, demoulding agents, plasticizers, marking agents and mixtures thereof.

The moulding compound according to the invention preferably contains as component (E) at least one stabiliser selected from the group consisting of inorganic and organic stabilisers, in particular antioxidants, antiozonants, heat stabilisers, light stabilisers, UV stabilisers, UV absorbers or UV blockers. Preferably, the stabiliser C is a UV and/or heat stabiliser.

According to a preferred embodiment, component (E) may be selected from the following group:
Compounds of monovalent or divalent copper, in particular salts of monovalent or divalent copper with inorganic or organic acids or monovalent or divalent phenols, the oxides of monovalent or divalent copper, or the complex compounds of copper salts with ammonia, amines, amides, lactams, cyanides or phosphines, preferably Cu(I) or Cu(II) salts of the hydrohalic acids, of hydrocyanic acids or the copper salts of aliphatic carboxylic acids, wherein particularly preferably the monovalent copper compounds CuCl, CuBr, Cul, CuCN and Cu₂O, as well as the divalent copper compounds CuCl₂, CuSO₄, CuO, copper(II) acetate or copper(II) stearate, or mixtures of these compounds, wherein these copper compounds are used as such or preferably in the form of concentrates. Concentrate means a polymer, preferably of the same or substantially the same chemical nature as component A1 or A2, which contains the copper salt or the copper compound in high concentration. In particular, the copper compounds are preferably used in combination with other metal halides, including alkali metal halides, such as Nal, KI, NaBr, KBr, wherein the molar ratio of metal halide to copper is 0.5 to 20, preferably 1 to 10 and particularly preferably 2 to 7;
stabilisers based on secondary aromatic amines;
stabilisers based on sterically hindered phenols;
phosphites and phosphonites,
stabilisers selected from the group consisting of N,N′-oxamides, hydroxyphenyltriazines, hydroxyphenylbenzotriazoles, dibenzoylmethanes, aminohydroxybenzoylbenzoic acid esters, hydroxybenzophenones, hindered amine light stabilisers (HALS), and
mixtures of the above-mentioned stabilisers.

Particularly preferred examples of stabilisers in relation to secondary aromatic amines which may be used according to the invention are adducts of phenylenediamine with acetone (Naugard A), adducts of phenylenediamine with linolenes, Naugard 445, N,N′-dinaphthyl-p-phenylenediamine, N-phenyl-N′-cyclohexyl-p-phenylenediamine or mixtures of two or more thereof.

Preferred examples of stabilisers usable in accordance with the invention based on sterically hindered phenols are N,N′-hexamethylene bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di.tert-butyl-4-hydroxyphenyl)-propionate, 4-4′-butylidene-bis-(3-methyl-6-tert.butylphenol), triethylene glycol 3-(3-tert-butyl-4-hydroxy-5-methylphenyl) propionate or mixtures of two or more of these stabilisers.

Preferred phosphites and phosphonites are triphenylphosphite, diphenylalkylphosphite, phenyldialkylphosphite, tris(nonylphenyl)phosphite, trilaurylphosphite, trioctadecylphosphite, distearylphentaerythritol diphosphite, tris(2,4-di-tert-butylphenyl)phosphite, diisodecylpenta-erythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris-(tert-butyl-phenyl)) pentaerythritol diphosphite, tristearylsorbitol diphosphite, tetrakis(2,4-di-tert-butylphenyl)-4,4′-biphenylenediphosphonite, 6-isooctyloxy-2,4,8,10-tetra-tert-butyl-12H-dibenz-[d,g]-1,3,2-dioxaphosphocin, 6-fluoro-2,4,8,10-tetra-tert-butyl-12-methyl-dibenz [d,g]-1,3,2-dioxaphosphocin, bis(2,4-di-tert-butyl-6-methylphenyl)methylphosphite and bis(2,4-di-tert-butyl-6-methylphenyl)ethylphosphite. In particular, tris[2-tert-butyl-4-thio(2′-methyl-4′-hydroxy-5′-tert-butyl)-phenyl-5-methyl] phenyl phosphite and tris(2,4-di-tert-butylphenyl)phosphite (Hostanox® PAR24: commercial product of Clariant, Basel).

A preferred embodiment of the heat stabiliser lies in the combination of Irgatec NC 66 (available from BASF) and a copper stabilization based on Cul and KI. Heat stabilisation based exclusively on Cul and KI is particularly preferred.

According to a further preferred embodiment, the heat stabilisers of component (E) are selected from the group of phenol-based heat stabilisers, phosphite-based heat stabilisers, amine-based heat stabilisers, or mixtures or combinations thereof, wherein component (E) is in particular preferably selected from the following group: triethylene glycol bis(3-tert-butyl-4-hydroxy-5-methylphenyl)propionate, pentaerythritol tetrakis(3-(3,5-di-tert-butyl-4-hydroxyphenyl)propionate), N,N′-hexamethylene bis[3-(3,5-di-t-butyl-4-hydroxyphenyl)propionamide], tris(2,4-di-tert-butylphenyl) phosphite, tris (2,4-di-tert-butylphenyl)phosphite, or mixtures thereof.

Preferred organic stabilisers are phenolic and/or phosphite compounds, such as Irganox 1010, Irganox 1098, Hostanox PAR 24 or Irgafos 168. Particularly preferred as component (E) is a mixture of 10 parts by weight of a mixture of Irganox 1010 (CAS 6683-19-8, phenolic antioxidant) and Anox 20 (CAS 6683-19-8, phenolic antioxidant) in a ratio of 7:3 and 2 parts by weight of Hostanox PAR24 (CAS: 31570 Apr. 4, tris (2,4-ditert-butylphenyl) phosphite).

Preferred UV stabilisers are, for example, selected from the group consisting of N-(2-ethoxyphenyl)-N′-(2-ethylphenyl)oxamide (Tinuvin 312), 2-(4,6-diphenyl-1,3,5-triazin-2yl)-5-hexyloxyphenol (Tinuvin 1577), 2-(4,6-diaryl-1, 3, 5-triazin-2yl)-5-(alkoxy substituted)-phenol (Tinuvin 1600), 2-tert-butyl-6-(5-chlorobenzotriazol-2-yl)-4-methylphenol (Tinuvin 326), 2-(benzo-triazol-2-yl)-4,6-bis(2-phenylpropan-2-yl)phenol (Tinuvin 234), bis(2,2,6,6,-tetramethyl-4-piperidyl)sebacate (Tinuvin 770 DF), N,N′-bis(2,2,6,6-tetramethyl-4-piperidinyl)isophthalamide (Nylostab S-EED), 2-(2-hydroxyphenyl)-benzotriazole derivative (Tinuvin Carboprotect), 2-(Benzotriazol-2-yl)-4,6-bis(2-methylbutan-2-yl)phenol (Tinuvin 328), 2-(Benzotriazol-2-yl)-6-[[3-(benzotriazol-2-yl)-2-hydroxy-5-(2,4,4-trimethylpentan-2-yl)phenyl]methyl]-4-(2,4,4-trimethylpentan-2-yl)-phenol (Tinuvin 360), poly[[6-[(1,1,3,3-tetra-methylbutyl) amino]-1,3,5-triazine-2,4-diyl][(2,2,6,6-tetramethyl-4-piperidinyl)-imino]-1,6-hexanediyl[(2,2,6,6-tetramethyl-4-piperidinyl)-imino]]) (Chimassorb 944), 1-(4-metoxyphenyl)-3-(4-tert-butylphenyl)-propane-1,3-dione (Parsol 1789) and mixtures thereof.

In a preferred embodiment, the thermoplastic polyamide moulding compound according to the invention consists of:
(A) 28-84.9 wt.-% of component (A) consisting of:
(A1) 20-100 wt.-%, preferably 40-85 wt.-% of at least one aliphatic semi-crystalline polyamide based on aliphatic dicarboxylic acids and aliphatic diamines;
(A2) 0-80 wt.-%, preferably 15-60 wt.-% of at least one amorphous partially aromatic polyamide and/or at least one amorphous and/or microcrystalline polyamide, wherein the wt.-% s of components (A1) and (A2) add up to 100 wt.-% of component (A);
(B) 15-50 wt.-% of mineral filler, consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% (B), respectively, wherein the component (B) has an aluminium oxide content of 5-20 wt.-%, and a silicon oxide content of 80-95 wt.-%, in relation to 100% of (B);
(C) 0-15 wt.-% of glass and/or carbon fibres;
(D) 0.1-3.0 wt.-% of black colourant, preferably carbon black;
(E) 0-4.0 wt.-% of additives;
   wherein the sum of (A)-(E) gives 100% of the thermoplastic polyamide moulding compound.

In a further preferred embodiment, the thermoplastic polyamide moulding compound according to the invention consists of:
(A) 50-79.8 wt.-% of component (A) consisting of:
(A1) 20-100 wt.-%, preferably 55-80 wt.-% of at least one aliphatic semi-crystalline polyamide selected from the group consisting of: 66, 66/BAC6, 610 or mixtures thereof;
(A2) 0-80 wt.-%, preferably 20-45 wt.-% of at least one amorphous partially aromatic polyamide selected from the group consisting of: 6T/6I and/or 10T/10I, each with a proportion of less than 50 mol % of 6T or 10T units, and/or at least one cycloaliphatic polyamide selected from the group consisting of: MACM12, PACM12, MACM12/PACM12, MACM14, MACM16 or mixtures thereof,
   wherein the wt.-% s of components (A1) and (A2) add up to 100 wt.-% of component (A);
(B) 20-45 wt.-% of mineral filler, consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% (B), respectively, wherein the component (B) has an aluminium oxide content of 5-20 wt.-%, and a silicon oxide content of 80-95 wt.-%, in relation to 100% of (B);
(D) 0.1-2.0 wt.-% of black colourant, preferably carbon black;
(E) 0.1-3.0 wt.-% of additives;
   wherein the sum of (A), (B), (D) and (E) is 100% of the thermoplastic polyamide moulding compound. In this preferred embodiment, the moulding compound is free of component (C), i.e., it does not contain any glass fibres and/or carbon fibres.

Furthermore, the present invention relates to the use of mineral fillers consisting of a mixture of 45 to 70 wt.-% of (crypto) crystalline silicic acid (B1), 5 to 15 wt.-% of amorphous silicic acid (B2) and 20 to 40 wt.-% of calcined kaolin (B3), in relation to 100 wt.-% of (B), respectively, wherein component (B) has an aluminium oxide content of 5-20 wt.-% and a silica content of 80-95 wt.-%, in relation to 100% of (B), in a black-coloured, mineral-filled polyamide moulding compound for improving the deep black colour impression, wherein the colour brightness L* of the polyamide moulding compound, determined according to DIN EN ISO 11664-4:2020 in the CIELAB colour space on a plate of the dimension 60×60×2 mm, is a maximum of 30, preferably a maximum of 28, particularly preferably a maximum of 27, if the gloss is included and is a maximum of 12, preferably a maximum of 8, particularly preferably a maximum of 6, if the gloss is excluded. Here too, the mineral filler according to the invention is preferably present in the polyamide moulding compound in a proportion in the range of 15 to 50 wt.-%, preferably in the range of 20 to 45 wt.-% in the moulding compound, in relation to the total weight of the polyamide moulding compound.

Further embodiments are given in the dependent claims.

### DESCRIPTION OF PREFERRED EMBODIMENTS

The components listed in Table 1 were compounded in the proportions shown in Tables 2 and 3 in a twin-screw extruder from Werner and Pfleiderer with a screw diameter of 25 mm under specified process parameters (see Table 4), wherein the polyamide granules and the additives were metered into the feed zone, while the mineral fillers were metered into the polymer melt 3 housing units upstream of the die via a side feeder. The compounds summarised in Tables 2 and 3 were drawn off as a strand from a 3 mm diameter die and granulated after water cooling. The granular material was dried for 24 hours at 100° C. in a vacuum of 30 mbar.

TABLE 1
Materials used in the examples and comparative examples

| Components | Description | Manufacturer |
|---|---|---|
| Polyamide 1 | PA 66, RV = 1.85, Tₘ = 260° C., | Radici (IT) |
| Polyamide 2 | PA 66/BAC6 (70:30), RV = 1.62, Tₘ = 225° C. | EMS-CHEMIE AG |
| Polyamide 3 | PA 66/BAC6 (60:40), RV = 1.60, Tₘ = 220° C. | EMS-CHEMIE AG |
| Polyamide 4 | PA 6I/6T (67:33), RV = 1.52, T_{g} = 125° C. | EMS-CHEMIE AG |
| Mineral 1 | Aktifit PF 115, calcined and aminosilane- | Hoffmann (DE) |
| (mineral according | functionalised Neuburg Siliceous Earth, L* = | |
| to the invention) | 96.4, particle size (D50) = 2.0 μm, BET surface | |
| | area = 9 m²/g, oil absorption value = 60 g/100 g, | |
| | silica content = 86 wt.-%, aluminium oxide | |
| | content = 13 wt.-%; mineral filler consisting of a | |
| | mixture of 45 to 70 wt.-% (crypto) crystalline | |
| | silicic acid, 5 to 15 wt.-% amorphous silicic acid | |
| | and 20 to 40 wt.-% calcined kaolin, in relation to | |
| | 100 wt.-% of the mineral, respectively, | |
| Mineral 2 | Translink 445, kaolinite surface-modified with | BASF SE (DE) |
| (mineral not | primary aminosilane, average particle size 1.4 | |
| according to the | μm (D50). | |
| invention) | | |
| Carbon black | Black Pearls 1100, lodine absorption (g/kg) 20, | Cabot Corp. (CH) |
| | OAN (cc/100 g): 105 (ASTM D-2414) | |
| Stabiliser | Irganox 1010 (CAS 6683-19-8) | BASF SE |
| Demoulder | Calcium stearate | |

TABLE 2
Moulding compounds according to the invention

| Components | Unit | B1 | B2 | B3 |
|---|---|---|---|---|
| Polyamide 1 (component A1) | wt.-% | | | 44.5 |
| Polyamide 2 (component A1) | wt.-% | 59.35 | | |
| Polyamide 3 (component A1) | wt.-% | | 59.35 | |
| Polyamide 4 (component A2) | wt.-% | | | 14.85 |
| Mineral 1 (component B) | wt.-% | 40 | 40 | 40 |
| Mineral 2 | wt.-% | | | |
| Carbon black (component D) | wt.-% | 0.25 | 0.25 | 0.25 |
| Stabiliser (component E) | wt.-% | 0.3 | 0.3 | 0.3 |
| Demoulder (component E) | wt.-% | 0.1 | 0.1 | 0.1 |
| Properties | | | | |
| L* value with gloss | | 26.4 | 26.5 | 26.7 |
| L* value without gloss | | 5.78 | 5.03 | 5.9 |
| E-modulus | MPa | 5600 | 5600 | 6200 |
| Breaking stress | MPa | 85 | 84 | 90 |
| Elongation at break | % | 2.3 | 2.2 | 3.0 |
| Impact strength, Charpy, 23° C. | kJ/m² | 42 | 40 | 68 |
| Notched impact strength, Charpy, 23° C. | kJ/m² | 2.7 | 2.7 | 4.0 |

TABLE 3
Moulding compounds of the comparative examples

| Components | Unit | CE1 | CE2 | CE3 |
|---|---|---|---|---|
| Polyamide 1 (component A1) | wt.-% | | | 44.5 |
| Polyamide 2 (component A1) | wt.-% | 59.35 | | |
| Polyamide 3 (component A1) | wt.-% | | 59.35 | |
| Polyamide 4 (component A2) | wt.-% | | | 14.85 |
| Mineral 1 (component B) | wt.-% | | | |
| Mineral 2 | wt.-% | 40 | 40 | 40 |
| Carbon black (component D) | wt.-% | 0.25 | 0.25 | 0.25 |
| Stabiliser (component E) | wt.-% | 0.3 | 0.3 | 0.3 |
| Demoulder (component E) | wt.-% | 0.1 | 0.1 | 0.1 |
| Properties | | | | |
| L* value with gloss | | 31.2 | 30.2 | 31.5 |
| L* value without gloss | | 17.9 | 16.2 | 18.1 |
| E-modulus | MPa | 6500 | 6400 | 6600 |
| Breaking stress | MPa | 96 | 95 | 102 |
| Elongation at break | % | 3.0 | 2.7 | 5.0 |
| Impact strength, Charpy, 23° C. | kJ/m² | 49 | 47 | 60 |
| Notched impact strength, Charpy, 23° C. | kJ/m² | 2.8 | 28 | 4.4 |

TABLE 4
Process parameter compounding

| Parameter | Temperature profile [° C.] |
|---|---|
| Temperature Zone 1 | 80-100 |
| Temperature Zone 2 | 230-250 |
| Temperature Zones 3 to 10 | 250-260 |
| Temperature Zone 11 | 250-270 |
| Temperature Zone 12 | 230-270 |
| Die head temperature | 260-280 |
| Melting temperature | 250-280 |
| Throughput [kg/h] | 8-12 |
| Screw speed [rpm] | 150-200 |

The compounds were injected using an Arburg Allrounder 320-210-750 injection moulding machine to form test specimens at defined cylinder temperatures in zones 1 to 4 of 240 to 280° C. and at a mould temperature of 100° C.

### Measurement Methods

The following measurement methods were used within the scope of this application:

### Melting Point (Tm) and Enthalpy of Fusion (ΔHm):

The melting point and enthalpy of fusion were determined on the granular material in accordance with ISO 11357-3 (2013). The DSC (Differential Scanning calorimetry) measurements were carried out at a heating rate of 20 K/min.

### Glass Transition Temperature, Tg:

The glass transition temperature T_{g} was determined on granular material using differential scanning calorimetry (DSC) in accordance with ISO 11357-2 (2013). This was carried out at a heating rate of 20 K/min for each of the two heating cycles. After initial heating, the sample was quenched in dry ice. The glass transition temperature (T_{g}) was determined during the second heating. The centre point of the glass transition range, which was specified as the glass transition temperature, was determined using the “half height” method.

### Relative Viscosity, ηᵣₑₗ:

The relative viscosity was determined according to ISO 307 (2007) at 20° C. For this purpose, 0.5 g of polymer granules were weighed into 100 ml of m-cresol (unless otherwise specified), and the relative viscosity (RV) was calculated according to RV=t/t₀ in accordance with section 11 of the standard.

### Tensile E-Modulus:

The tensile E-modulus was determined in accordance with ISO 527 (2012) at 23° C. with a tensile speed of 1 mm/min on an ISO tensile bar (type A1, dimensions 170×20/10×4) in accordance with the standard: ISO/CD 3167 (2003).

### Breaking Stress and Elongation at Break:

The determination of breaking stress and elongation at break was carried out in accordance with ISO 527 (2012) at 23° C. with a tensile speed of 5 mm/min on an ISO tensile bar, type A1 (dimensions 170×20/10×4 mm), manufactured in accordance with the ISO/CD 3167 (2003) standard.

### Impact Strength According to Charpy:

The Charpy impact strength was determined in accordance with ISO 179/2*eU (1997, * 2=instrumented) at 23° C. on an ISO test bar, type B1 (dimensions 80×10×4 mm), manufactured in accordance with the ISO/CD 3167 (2003) standard.

### Notched Impact Strength According to Charpy:

The Charpy notched impact strength was determined in accordance with ISO 179/2*eA (1997, * 2=instrumented) at 23° C. on an ISO test bar, type B1 (dimensions 80×10×4 mm), manufactured in accordance with the ISO/CD 3167 (2003) standard.

### Colour Measurement and Determination of Luminance (Colour Brightness L*)

The CIE L*a*b* values of reference and test colour plates were measured with a spectrophotometer from Datacolor (apparatus name: Datacolor 650) under the following measurement conditions according to DIN EN ISO 11664-4:2020 in front of a white-coated contrast sheet; measurement mode A: Reflection, measurement geometry: D/8°, illuminant: D 65 10, gloss: included, calibration: UV-calibrated, measurement aperture: SAV, measurement mode B: Reflection, measurement geometry: D/8°, illuminant: D 65 10, gloss: excluded, calibration: UV-calibrated, measurement aperture: SAV.

### Discussion of the Results:

The comparative examples CE1 to CE3 based on a surface-coated kaolinite, i.e., a mineral of the prior art, all have a colour brightness L* with gloss of over 30 and a colour brightness L* without gloss in the range of 16 to 18. The assessment of the corresponding colour plates by eye results in an anthracite grey appearance. By contrast, the coloured plates produced with the moulding compounds of examples E1 to E3 according to the invention appear deep black. This is also reflected in the colour brightness L* of these examples, which is below 27 when measured with gloss and below 6 when measured without gloss. The mechanical properties of the moulding compounds according to the invention are at a good level, even if the E-modulus and the breaking stress in particular are somewhat lower than those of the comparative examples.

1-16. (Canceled)

17. A thermoplastic polyamide moulding compound consisting of:
A 20-89.9 wt.-% of at least one polyamide;
B 10-55 wt.-% of mineral filler, consisting of a mixture of 45 to 70 wt.-% of crypto crystalline silicic acid B1, 5 to 15 wt.-% of amorphous silicic acid B2 and 20 to 40 wt.-% of calcined kaolin B3, in relation to 100 wt.-% of B, respectively, wherein the component B has an aluminium oxide content of 5-20 wt.-%, and a silicon oxide content of 80-95 wt.-%, in relation to 100% of B;
C 0-15 wt.-% of glass fibers and/or carbon fibers
D 0.1-5.0 wt.-% of black colorant; and
E 0-5.0 wt.-% of additives;
wherein the sum of A to E is 100% of the thermoplastic polyamide moulding compound,
and wherein the thermoplastic polyamide moulding compound has a color brightness L*, determined according to DIN EN ISO 11664-4:2020 in the CIELAB color space on a plate of the dimension 60×60×2 mm, of a maximum of 30 if the gloss is also measured and of a maximum of 12 if the gloss is not also measured.

18. The thermoplastic polyamide moulding compound according to claim 17, wherein component A is present in a proportion of 28-84.9 wt.-% in relation to components A to E.

19. The thermoplastic polyamide moulding compound according to claim 17, wherein component A consists of:
A1 20-100 wt.-% of at least one aliphatic semi-crystalline polyamide based on aliphatic dicarboxylic acids and aliphatic diamines and/or at least one partially aromatic semi-crystalline polyamide based on dicarboxylic acids and diamines;
A2 0-80 wt.-% of at least one amorphous polyamide, wherein the wt.-% of components A1 and A2 add up to 100 wt.-% of component A.

20. The thermoplastic polyamide moulding compound according to claim 17,
wherein the polyamides of component A1 are semi-crystalline aliphatic polyamides selected from the group consisting of PA 6, 46, 56, 66, 66/BAC6, 66/6, 69, 610, 612, 614, 616, 618, 810, 1010, 1012, 1212, 11, 12, 6/12, and 66/6/610,
and/or are semi-crystalline partially aromatic polyamides selected from the group consisting of: PA 6T/6I, 6T/66, 6T/6I/66, 6T/610, 6T/612, 6T/614, 6T/616, 9T, 9MT (M=2-methyloctane-1,8-diamine), 10T, 11T, 10T/6T, 11T/6T, 12T, 10T/6T, 11/10T, 12/10T, 11/9T, 12/9T, 10T/1010, and 10T/612,
and/or are semi-crystalline polyamides, which have a melting point of at least 170° C.

21. The thermoplastic polyamide moulding compound according to claim 17, wherein the polyamides of component A2
are selected from the group consisting of the amorphous polyamides 12/MACMT, MACM10, MACM12, MACM14, MACM16, MACM18, MACMI/12, PACM10, PACM12, PACM14, PACM16, PACM18, PACMI/12, TMDC10, TMDC12, TMDC16, TMDC18, MACMT/MACMI/12, PACMT/PACMI/12, and mixtures thereof, and/or
are selected from the group consisting of the amorphous polyamides MXDI, MXDI/6I, MXD6/MXDI, 6I, 6/6I, 6T/6I, 10T/10I, 3-6T (3-6 =2,2,4-or 2,4,4-trimethylhexanediamine) or mixtures thereof, wherein the systems 6T/6I or 10T/10I have a proportion of less than 50 mol % 6T or 10T units, and/or
are amorphous polyamides which have a glass transition temperature (Tg) above 90° C.

22. The thermoplastic polyamide moulding compound according to claim 17, wherein component B is present in a proportion in the range of 15-50 wt.-%, in relation to components A to E.

23. The thermoplastic polyamide moulding compound according to claim 17, wherein component B is surface-treated with a silane compound.

24. The thermoplastic polyamide moulding compound according to claim 23, wherein the silane compound is selected from the group consisting of trialkoxysilanes, dialkoxysilanes, epoxysilanes, vinylsilanes, (meth)acryloxysilanes, aminosilanes, and mercaptosilanes.

25. The thermoplastic polyamide moulding compound according to claim 17, wherein component B is surface-coated with a primary and/or secondary aminosilane.

26. The thermoplastic polyamide moulding compound according to claim 25, wherein component B is surface-coated with a secondary aminosilane.

27. The thermoplastic polyamide moulding compound according to claim 25, wherein the amount of the primary and/or secondary aminosilane is 0.01 to 2.0 wt.-%, in relation to component B.

28. The thermoplastic polyamide moulding compound according to claim 17, wherein component C is a glass fiber.

29. The thermoplastic moulding compound according to claim 17, wherein component D is present in a proportion in the range of 0.1-3.0 wt.-% in relation to components A to E; and/or
component D is selected from the group consisting of: carbon black, graphite, graphene, nigrosine, black colour pigments, black dyes, and combinations of complementary colored pigments and/or dyes.

30. The thermoplastic polyamide moulding compound according to claim 17, wherein component E is present in a proportion in the range of 0-4.0 wt.-%, in relation to components A to E.

31. The thermoplastic polyamide moulding compound according to claim 17, wherein the additives of component E are selected from the group consisting of stabilizers, anti-ageing agents, antioxidants, antiozonants, light stabilisers, UV stabilisers, UV absorbers, UV blockers, inorganic heat stabilizers, organic heat stabilizers, conductivity additives, optical brighteners, processing aids, nucleating agents, crystallisation accelerators, crystallisation retarders, flow aids, lubricants, demoulding agents, plasticizers, marking agents, and mixtures thereof.

32. The thermoplastic polyamide moulding compound according to claim 17, wherein the moulding compound consists of:
A 28-84.9 wt.-% of component A consisting of A1, which is 20-100 wt.-% of at least one aliphatic semi-crystalline polyamide based on aliphatic dicarboxylic acids and aliphatic diamines; and A2, which is 0-80 wt.-% of at least one amorphous polyamide, wherein the wt.-% s of components A1 and A2 add up to 100 wt.-% of component A;
B 15-50 wt.-% of mineral filler consisting of a mixture of 45 to 70 wt.-% of crypto crystalline silicic acid B1, 5 to 15 wt.-% of amorphous silicic acid B2, and 20 to 40 wt.-% of calcined kaolin B3, in relation to 100 wt.-% of B, respectively, wherein component B has an aluminium oxide content of 5-20 wt.-%, and a silicon oxide content of 80-95 wt.-%, in relation to 100% of B;
C 0-15 wt.-% of glass and/or carbon fibers;
D 0.1-3.0 wt.-% of black colorant; and
E 0-4.0 wt.-% of additives;
wherein the sum of A to E is 100% of the thermoplastic polyamide moulding compound.

33. The thermoplastic polyamide moulding compound according claim 32, wherein the moulding compound consists of:
A 50-79.8 wt.-% of component A consisting of:
A1 20-100 wt.-% of at least one aliphatic semi-crystalline polyamide selected from the group consisting of: 66, 66/BAC6, 610, and mixtures thereof; and
A2 0-80 wt.-% of at least one amorphous partially aromatic polyamide selected from the group consisting of: 6T/6I and/or 10T/10I, with a proportion of less than 50 mol % of 6T or 10T units, respectively, wherein the wt.-% s of components A1 and A2 add up to 100 wt.-% of component A;
B 20-45 wt.-% of mineral filler consisting of a mixture of 45 to 70 wt.-% of crypto crystalline silicic acid B1, 5 to 15 wt.-% of amorphous silicic acid B2 and 20 to 40 wt.-% of calcined kaolin B3, in relation to 100 wt.-% of B, respectively, wherein the component B has an aluminium oxide content of 5-20 wt.-%, and a silicon oxide content of 80-95 wt.-%, in relation to 100% of B;
D 0.1-2.0 wt.-% of black colorant; and
E 0.1-3.0 wt.-% of additives;
wherein the sum of A, B, D and E is 100% of the thermoplastic polyamide moulding compound.

34. The thermoplastic polyamide moulding compound according to claim 17, wherein the polyamide moulding compound has a color brightness L*, determined according to DIN EN ISO 11664-4:2020 in the CIELAB color space on a plate of the dimension 60×60×2 mm, of a maximum of 28, if the gloss is also measured and of a maximum of 8, if the gloss is not measured.

35. A moulded body which contains a polyamide moulding compound according to claim 17.

36. A method for enhancing a deep black color impression in a black-colored, mineral-filled polyamide moulding compound wherein a color brightness L* of the polyamide moulding compound, determined according to DIN EN ISO 11664-4:2020 in the CIELAB color space on a plate of the dimension 60×60×2 mm, is a maximum of 30 if the gloss is included and is a maximum of 12 if the gloss is excluded, the method comprising including mineral fillers (B) in the polyamide moulding compound, wherein the mineral fillers consist of a mixture of 45 to 70 wt.-% of crypto crystalline silicic acid B1, 5 to 15 wt.-% of amorphous silicic acid B2, and 20 to 40 wt.-% of calcined kaolin B3, in relation to 100 wt.-% of B, respectively, wherein the component B has an aluminium oxide content of 5-20 wt.-% and a silicon oxide content of 80-95 wt.-%, in relation to 100% of B, in a black-colored, mineral-filled polyamide moulding compound.
